(19) United States
(12) Patent Application Publication
(10) Pub. No.: US 2017/0348899 A1
(43) Pub. Date: Dec. 7, 2017

(54) GENERATING AND AUTHENTICATING AN ADDITIVE MANUFACTURING ITEM USING TAGS

(71) Applicant: TruTag Technologies, Inc., Kapolei, HI (US)

(72) Inventors: Michael P. O'Neill, Kaneohe, HI (US); Timothy Learmonth, Berkeley, CA (US); Hod Finkelstein, El Cerrito, CA (US)

(21) Appl. No.: 14/885,875

(22) Filed: Oct. 16, 2015

Related U.S. Application Data
(60) Provisional application No. 62/076,893, filed on Nov. 7, 2014.

(51) Int. Cl. B29C 64/10; B29C 64/20; B33Y 40/00; B33Y 10/00; B33Y 30/00

(52) U.S. Cl. CPC B29C 64/10; B29C 64/20; B33Y 30/00; B33Y 10/00; B33Y 40/00

(57) ABSTRACT

A system for generating an item includes an input receiver and an additive manufacturing device. The input receiver is to receive an additive manufacturing material and a plurality of tags. The additive manufacturing device is to generate an additive manufacturing item using the additive manufacturing material and the plurality of tags.

### CROSS REFERENCE TO OTHER APPLICATIONS

This application claims priority to U.S. Provisional Patent Application No. 62/076,893 entitled AUTHENTICATION OF ADDITIVE MANUFACTURING USING TAGS filed Nov. 7, 2014 which is incorporated herein by reference for all purposes.

### BACKGROUND OF THE INVENTION

A producer or reseller of items (including ingredients and components of such items)—for example an additive manufacturer, but also including other parties in the entire supply and distribution chain such as a supplier, a wholesaler, a distributor, a repackager, and a retailer—especially, but not limited to, high-value items, faces counterfeiting of the item using unauthorized additive manufacturing. This leads to loss of potential revenue as counterfeit items are sold in the place of the real item. Also, there can be health or product related damages caused by not using an authentic item as opposed to a counterfeit—for example, the counterfeit can perform differently or not at all as compared to an authentic item. This is particularly acute in industries that can affect health and safety such as industries involved with construction, transportation, and defense.

As international criminal organizations become more sophisticated, existing packaging security is proving inadequate. In complex product supply chains and markets with variable pricing, opportunities for arbitrage exist for unscrupulous parties to misrepresent product pricing without any change to the underlying product, and thus benefit monetarily, for example, as in returns, rebate or charge-back fraud. Monetary gain or loss to either side of a transaction may also result from errors in record-keeping.

In addition to counterfeiting or product misrepresentation, items that appear physically identical or similar, for example simple lenses may actually have different optical properties, but because of similar appearance may be unintentionally packaged or labeled incorrectly. Even if the items are otherwise identical, they may have different properties associated with the particular lot or batch conditions.

### BRIEF DESCRIPTION OF THE DRAWINGS

Various embodiments of the invention are disclosed in the following detailed description and the accompanying drawings.

FIG. 1 is a block diagram illustrating an embodiment of a system for generating an item.

FIG. 2 is a block diagram illustrating an embodiment of an additive manufacturing system.

FIG. 3 is a diagram illustrating an embodiment of an additive manufacturing device.

FIG. 4 is a diagram illustrating an embodiment of an additive manufacturing device.

FIG. 5 is a diagram illustrating an embodiment of an additive manufacturing device.

FIG. 6 is a block diagram illustrating an embodiment of a spectral reader system.

FIG. 7 is a diagram illustrating an embodiment of a spectral reader.

FIG. 8 is a flow diagram illustrating an embodiment of a process for generating an item.

FIG. 9 is a flow diagram illustrating an embodiment of a process for generating an item.

FIG. 10 is a flow diagram illustrating an embodiment of a process for generating an item.

FIG. 11 is a flow diagram illustrating an embodiment of a process for authenticating.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for generating an item comprises an additive manufacturing material, a plurality of tags, and an additive manufacturing device. The additive manufacturing device is to generate an additive manufacturing item using the additive manufacturing material and the plurality of tags.

Authentication of additive manufacturing using tags is disclosed.

In some embodiments, tags comprise rugate tags. In various embodiments, tags comprise one of the following materials: silicon, silicon nitride, doped silicon, or any other appropriate material. In some embodiments, tags are made of silica (deemed “generally recognized as safe”—or GRAS—by the FDA), rendering them biologically inert and edible.

Each barely visible tag contains a custom-manufactured spectral signature chosen so as to uniquely identify or authenticate a particular product. Tags with a given spectral signature are manufactured in quantities sufficient to enable cost-effective identification of commercial-scale product volumes. The number of available spectral signature combinations range from identifying product manufacturer or brand, to product type or model, to individual lot or batch numbers across multiple industries and markets.

In some embodiments, the unique optical signature of each tag can be read by a spectral reader. In some embodiments, tags comprise the surface of a silicon wafer that is etched to have a spectral code encoded by the etching. A thin layer from the surface of the etched wafer is removed and divided into small tags, and the resultant tags contain a complex porous nanostructure that is programmed during electrochemical synthesis to display a unique reflectivity spectrum. The tags are then oxidized by a high-temperature bake step to turn the crystalline, nanoporous silicon tags into amorphous, nanoporous silica. This bake step stabilizes the nanoporous structure against further oxidation (thus stabilizing the spectral signature) and provides for the tags to be characterized as a GRAS excipient.

In some embodiments, the spectrum of a tag is measured via a spectrometer-based reader, then verified against other information as part of a database or located on a label or package. The tags can also be used on their own acting simply as labels for quality assurance or other purposes. Information can be encoded using peak number, peak placement, peak rugate phase, and/or peak amplitude as modulation parameters. The tags are passive, inconspicuous and can be attached or embedded in items—for example, items that are manufactured using additive manufacturing techniques.

In some embodiments, the tag properties comprise:
Inconspicuous size range (≈50 to 100 micrometers) allows covert or semi-covert use
Inert
High temperature resistance—melting point above 1000° C.
Passive—no energy input or output
Can be used in or on a product, package, or label
Can be embedded within or on the surface of or applied via sprays, coatings, varnishes, or as part of laminate
Can be integrated at a number of manufacturing stages
High level of security possible; can be scaled to suit specific product needs
Can be made self-authenticating and reduce the costs and security risks associated with online databases and maintenance

In some embodiments, the spectral reader determines the presence of a tag. In some embodiments, the spectral reader determines a spectral reflectance content of a tag. In some embodiments, the spectral reader determines a density of tags (e.g., number of tags per unit area). In some embodiments, the spectral reader determines whether there is a minimum number of tags in the field of view.

In some embodiments, the tags are small and inexpensive. In some embodiments, tags are localized during the manufacturing and placed in a location to be read or exposed to be read. In some embodiments, tags are distributed throughout a manufactured item leading to a cost increase compared to a localized application.

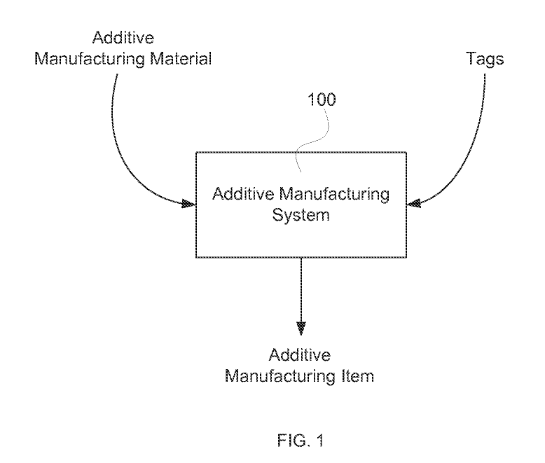

FIG. 1 is a block diagram illustrating an embodiment of a system for generating an item. In the example shown, additive manufacturing system 100 receives additive manufacturing material and tags and generates an additive manufacturing item. For example, an additive manufactured item is built up by adding material selectively and selectively adding tags that are later used to authenticate the item. In various embodiments, the additive manufacturing material comprises a material that is made fixed or rigid in a way that forms an item—for example, a material that is extruded spatially to compose an item, a material that is selectively cooled, cured, sintered, polymerized, or any other appropriate manner of additively manufacturing an item. In some embodiments, an additive manufacturing technique comprises stereo lithography in which beams of UV rays are concentrated on a resin (e.g., a photopolymer) that selectively solidifies the resin to build a shape. In some embodiments, an additive manufacturing technique comprises fused deposition modeling in which drops of melted thermoplastic material are selectively joined together to form a shape that harden when cooled. In some embodiments, an additive manufacturing technique comprises selective laser sintering in which a binder mixed with a powder (e.g., nylon, ceramic, glass, aluminum, steel, silver, etc.) is selectively melted to bind the powder to form a shape using a laser. In some embodiments, an additive manufacturing technique comprises selective laser melting in which a powder is melted using a laser to selectively form a shape. In some embodiments, an additive manufacturing technique comprises electron beam melting in which electron beams are used to selectively solidify a material to build a shape. In some embodiments, an additive manufacturing technique comprises laminated object manufacturing in which an object is manufactured by gluing together various materials, for example, plastic, paper, and metal and then cutting the material with a knife or a laser to give the material a shape.

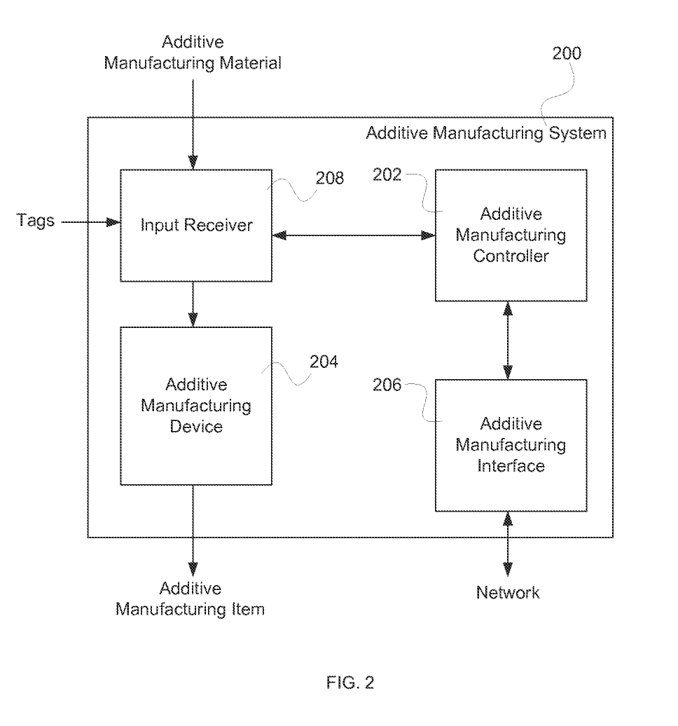

FIG. 2 is a block diagram illustrating an embodiment of an additive manufacturing system. In some embodiments, additive manufacturing system 200 is used to implement additive manufacturing system 100 of FIG. 1. In the example shown, additive manufacturing system 200 comprises input receiver 208, additive manufacturing device 204, additive manufacturing controller, and additive manufacturing interface 206. Additive manufacturing controller 202 is instructed via additive manufacturing interface 206 to generate a specific item. For example, a design user provides instructions via a network to additive manufacturing system 200 to make an additive manufacturing item. Additive manufacturing material and tags are received by input receiver and provided to additive manufacturing device 204. Additive manufacturing device 204 based on the instructions adds additive manufacturing material increment by increment to build up an additive manufacturing item. At appropriate locations, additive manufacturing device 204 embeds into or adds to a surface of additive manufacturing material tags that enable authentication of the additive manufacturing item. In some embodiments, additive manufacturing material comprises one or more substances with appropriate mechanical, physical, optical, or other properties for constructing the additive manufacturing item. In various embodiments, the tags are embedded in one or more of the following: an optical transparent material (e.g., a material in which the tags can be optically read), an optically opaque material (e.g., a material in which the tags can be read after the material is broken open, dissolved, deconstructed, etc. to expose the tags), or any other appropriate material.

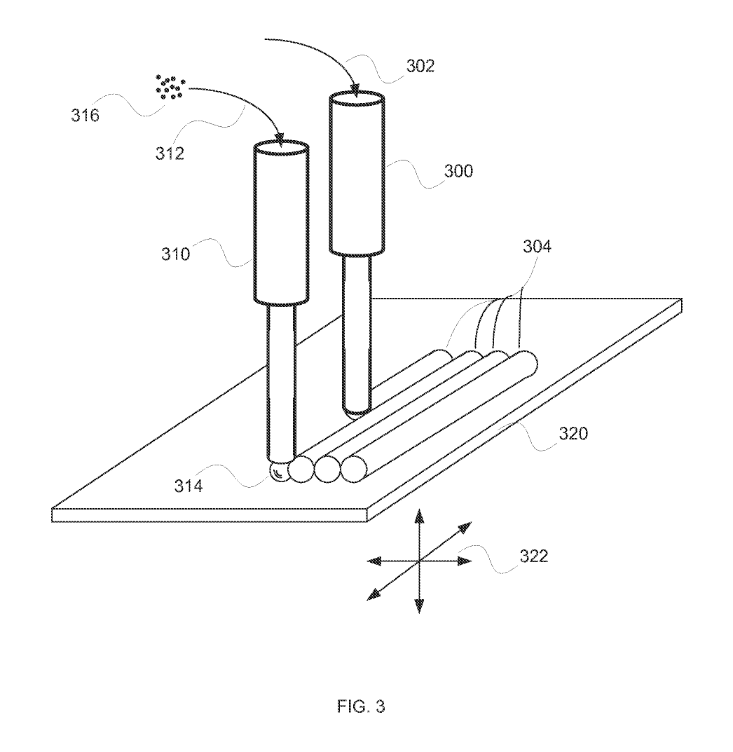

FIG. 3 is a diagram illustrating an embodiment of an additive manufacturing device. In some embodiments, the additive manufacturing device of FIG. 3 is used to implement additive manufacturing device 204 of FIG. 2. In the example shown, the extruder 300 extrudes material entering along path 302 to make layers that build up an item as extruded lines 304 (e.g., material is extruded which then later becomes fixed or rigid—for example, by cooling, curing, polymerizing, etc.). The system positions substrate 320 so that extruded material from extruder 300 is placed appropriately to make the item. Substrate 320 can be moved in all three dimensions 322 to enable the placement of extruded material using extruder 300. Extruder 310 extrudes material entering along path 312 that includes tags 316. Extruder 310 selectively places tags 316 laden material to be at a specific predetermined location within or on the surface of the item. Later knowing the specific location where tags 316 are placed, a reader can be directed to read tags 316 (e.g., surface located tags) or tags 316 can be extracted from the manufactured item and read using a reader. In various embodiments, material entering along path 302 is the same as material entering along path 312, is different from material entering along path 312, or any other appropriate relation between the materials entering along paths 302 and 312. In some embodiments, the material entering along path 302 is selected for the properties appropriate for the item (e.g., properties related to strength, weight, durability, thermal, electrical, etc.). In some embodiments, the material entering along path 312 is selected for the properties appropriate for the tags and reading or preserving the tags (e.g., tag contrast, tag visibility, transparency, etc.). In some embodiments, there is only one extruder and the two different materials are put into the single extruder at the appropriate times. In some embodiments, the appropriate time is determined by the location tags 316 are desired to be placed within the manufactured item.

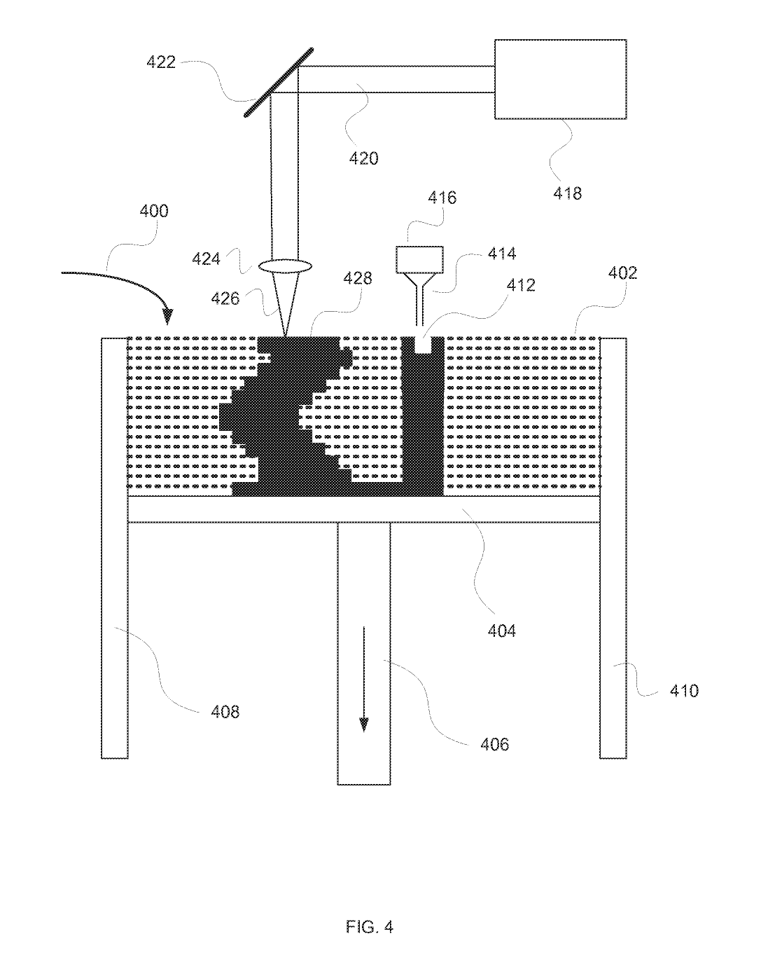

FIG. 4 is a diagram illustrating an embodiment of an additive manufacturing device. In some embodiments, the additive manufacturing device of FIG. 4 is used to implement additive manufacturing device 204 of FIG. 2. In the example shown, liquid 402 that can be polymerized is added to a variable depth well (e.g., well with side wall 408 and side wall 410 and movable bottom 404 as actuated by piston 406). Liquid 402 can be addressed using light source 418 whose light beam 420 is directed (e.g., using mirror 422 and lens 424) to the surface of liquid 402 (e.g., focused beam 426) to be polymerized to produce a desired item shape (e.g., item 428). The location of polymerization can be changed by moving the location of focused beam 426 over the surface of liquid 402. One layer of item locations is polymerized by the light and then the well is made deeper and liquid 402 is added to build up a desired item again by moving the location of the focused light to achieve polymerization at desired locations. Tags can be placed within or on the surface of a generated item using reservoir 416 and injector 414 to place tags and tag medium at desired locations on the surface of the item or embedded in the item. In some embodiments, tag medium is selected to optimize contrast for the tags or to encapsulate the tags or to enable reading of the tags. Item 428 is removed from liquid 402. Item 428 can be used directly (e.g., in the event that the polymerized material is appropriate for the desired use).

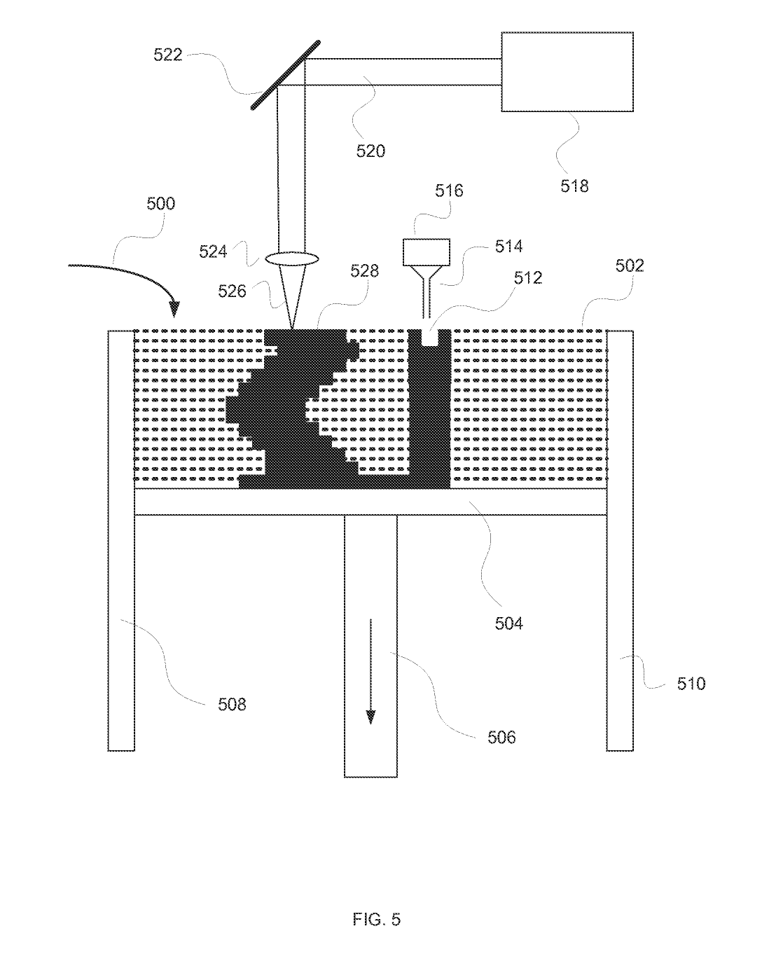

FIG. 5 is a diagram illustrating an embodiment of an additive manufacturing device. In some embodiments, the additive manufacturing device of FIG. 5 is used to implement additive manufacturing device 204 of FIG. 2. In the example shown, powder 502 that can be sintered is added to a variable depth well (e.g., well with side wall 508 and side wall 510 and movable bottom 504 as actuated by piston 506). Powder 502 can be addressed using light source 518 whose light beam 520 is directed (e.g., using mirror 522 and lens 524) to the surface of powder 502 (e.g., focused beam 526) to be sintered or solidified to produce a desired item shape (e.g., item 528). The location of sintering can be changed by moving the location of focused beam 526 over the surface of powder 502. One layer of item locations is sintered by the light and then the well is made deeper and powder 502 is added to build up a desired item again by moving the location of the focused light to achieve sintering at desired locations. Tags can be placed within or on the surface of a generated item using reservoir 516 and injector 514 to place tags and tag medium at desired locations on the surface of the item or embedded in the item. In some embodiments, tag medium is selected to optimize contrast for the tags or to encapsulate the tags or to enable reading of the tags. Item 528 is removed from powder 502. Item 528 can be used directly (e.g., in the event that the sintered material is appropriate for the desired use).

In some embodiments, the sintering system has all of the powder placed in the volume at once, and there is no piston or well or funnel feed.

In various embodiments, other additive manufacturing can be adapted to include localized tags for authentication, quality assurance, labeling or any other appropriate function.

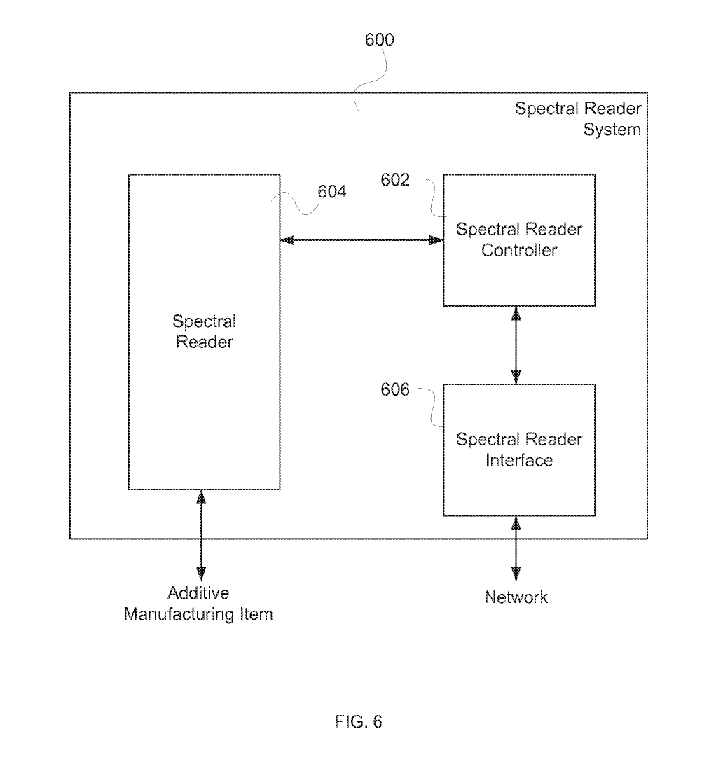

FIG. 6 is a block diagram illustrating an embodiment of a spectral reader system. In some embodiments, spectral reader system 600 is used to authenticate an additive manufacturing item made using additive manufacturing system 100 of FIG. 1. In the example shown, spectral reader system 600 comprises spectral reader control 602, spectral reader 604, and spectral reader interface 606. Spectral reader 604 illuminates an additive manufacturing item with light from a broadband illumination source and detects back-reflected light from the additive manufacturing item. Spectral reader 604 measures spectral content of the back-reflected light to detect spectral responses (e.g., the amplitude or power response of the back-reflected light at different light frequencies or wavelengths). The spectral content is provided to spectral reader controller 602 and is compared to information stored in a database that associates spectral content and tag information and/or manufacturing item information. In various embodiments, information to spectral reader controller 602 is provided from the database which is located locally to spectral reader controller 602 (e.g., attached or part of the spectral reader system), not locally to spectral reader controller 602 (e.g., connected via a network and communicated with using spectral reader interface 606), or at any other appropriate location.

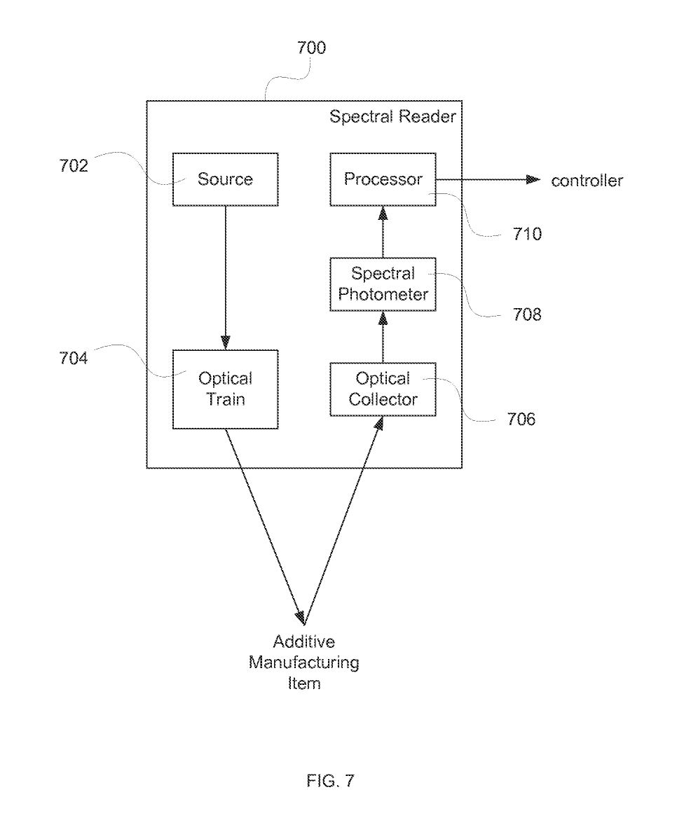

FIG. 7 is a diagram illustrating an embodiment of a spectral reader. In some embodiments, spectral reader 700 is used to implement spectral reader 604 of FIG. 6. In the example shown, source 702 (e.g., a wide bandwidth source, 400-800 nm source, one or more sources that generate enough wavelengths to be perceived as wide bandwidth—for example, multiple discrete wavelengths or a broadband source) provides illumination for an object (e.g., an additive manufacturing item). In some embodiments, the illumination is provided to the object using optical train 704. In some embodiments, optical train 704 comprises an illumination fiber bundle and focusing optics. In some embodiments, optical train 704 conditions source 702 (e.g., a wide bandwidth source) providing illumination to be transmitted by optical train 704 (e.g., where optical train 704 comprises coupling optics including lenses, filters, a fiber bundle, focusing optics, etc.). In some embodiments, illumination comprises a flood illumination using a white or wide bandwidth source. In some embodiments, the illumination fiber bundle comprises multiple fibers. In some embodiments, the focusing optics comprise one or more optical lenses or elements that take the output of the illumination fiber bundle and focuses the illumination on an object. Reflected illumination from the object is received by optical collector 706 and is provided to spectral photometer 708. Spectral photometer 708 determines a spectrum of the reflected illumination (e.g., spectral content information) from the object. The spectral information is provided to a processing unit (e.g., processor 710). In some embodiments, the processing unit comprises one or more of the following: a processor (e.g., a hardware processor or computer processor), a memory, an interface, or any other appropriate processing components. In various embodiments, illumination and collection is done using a fiber bundle, is not done using a fiber bundle, is done using an optical lens system, or is done in any other appropriate manner. In some embodiments, processor 710 provides spectral content information to controller for comparison to database information enabling authentication of the additive manufacturing item.

In some embodiments, spectral content information is matched to database information that identifies information related to an authentic additive manufacturing item (e.g., item source, item manufacturer, item design, item brand, item serial number, item type, item provenance, tag source, tag type, tag provenance, etc.). In some embodiments, database information is received from a database located local to the spectral reader system. In various embodiments, database information is received from a database located in the cloud, at a remote location, at an authentication server, or any other appropriate location.

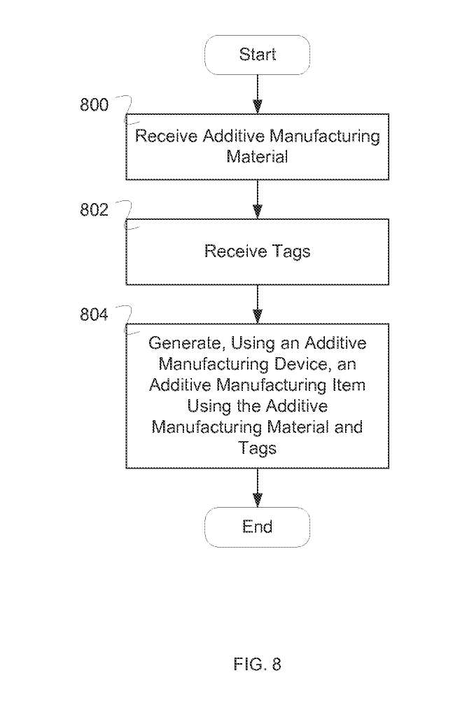

FIG. 8 is a flow diagram illustrating an embodiment of a process for generating an item. In some embodiments, the process of FIG. 8 is implemented using additive manufacturing system 100 of FIG. 1 or additive manufacturing system 200 of FIG. 2. In the example shown, in 800 additive manufacturing material is received. For example, an input receiver of an additive manufacturing system receives additive manufacturing material. In 802, tags are received. In 804, an additive manufacturing item is generated using an additive manufacturing device using the additive manufacturing material and the tags. For example, the item is built up of the material into a desired shape and the tags are placed in a desired location so that the item can be later authenticated. In some embodiments, the tags include an identification code that is matched to the item and manufacturing system. In some embodiments, the code and corresponding matched item and manufacturing system are stored in a database. In some embodiments, the code is read off an item using a reader to read the tags and then the item is checked against stored data in a database for authentication.

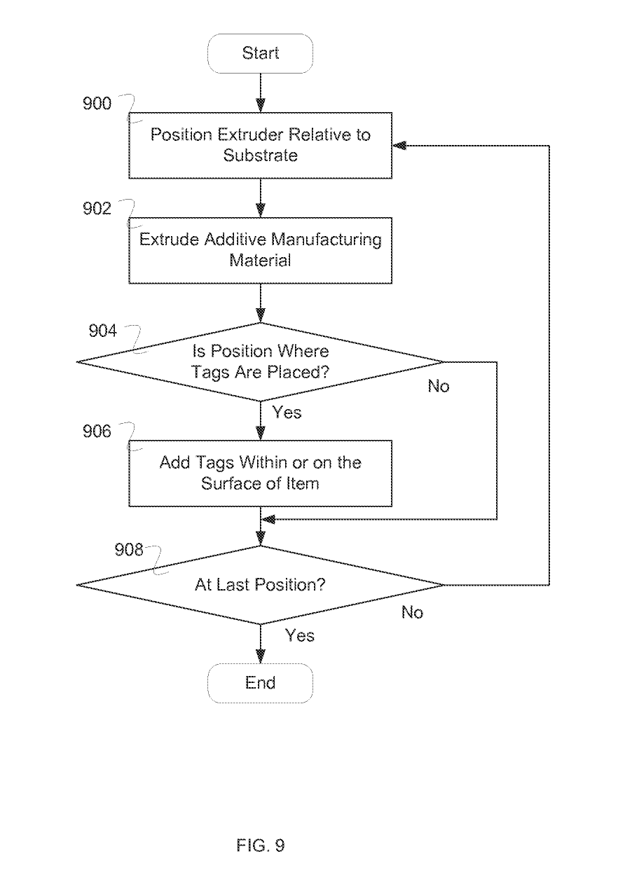

FIG. 9 is a flow diagram illustrating an embodiment of a process for generating an item. In some embodiments, the process of FIG. 9 implements 804 of FIG. 8. In the example shown, in 900 an extruder is positioned relative to a substrate. For example, the substrate that holds the item as it is being built up is positioned relative to the extruder of material so that the extruder can selectively add material to the item as it is being built up. In 902, additive material is extruded. For example, the material is extruded at the location determined by the relative position to build up the item. In 904, it is determined whether the position is where tags are to be placed. In the event that the position is not where tags are to be placed, then control passes to 908. In the event that the position is where tags are to be placed, in 906 tags are added within or on the surface of the item. For example, the tags are embedded within or on the surface in a material that enables reading the tags while embedded or after removing the tags from the item (e.g., for a destructive forensic reading). In 908, it is determined whether it is at the last position. In the event that it is not at the last position, control passes to 900. In the event that it is at the last position, the process ends.

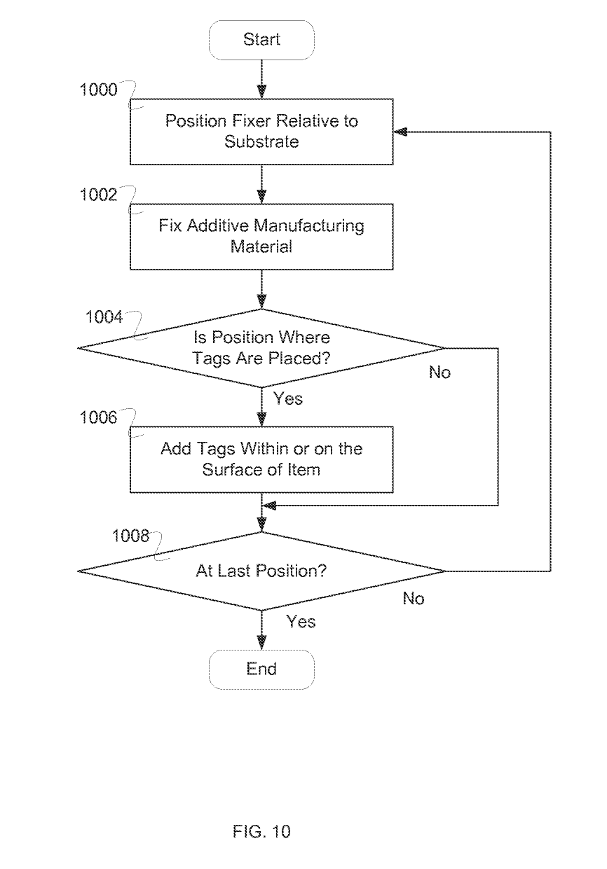

FIG. 10 is a flow diagram illustrating an embodiment of a process for generating an item. In some embodiments, the process of FIG. 10 implements 804 of FIG. 8. In the example shown, in 1000 a fixer is positioned relative to a substrate. For example, the substrate that holds the item as it is being built up is positioned relative to the fixer of material so that the fixer can selectively fix material to the item as it is being built up. In 1002, additive material is fixed. For example, the material is fixed at the location determined by the relative position to build up the item. In 1004, it is determined whether the position is where tags are to be placed. In the event that the position is not where tags are to be placed, then control passes to 1008. In the event that the position is where tags are to be placed, in 1006 tags are added within or on the surface of the item. For example, the tags are embedded within or on the surface in a material that enables reading the tags while embedded or after removing the tags from the item (e.g., for a destructive forensic reading). In 1008, it is determined whether it is at the last position. In the event that it is not at the last position, control passes to 1000. In the event that it is at the last position, the process ends.

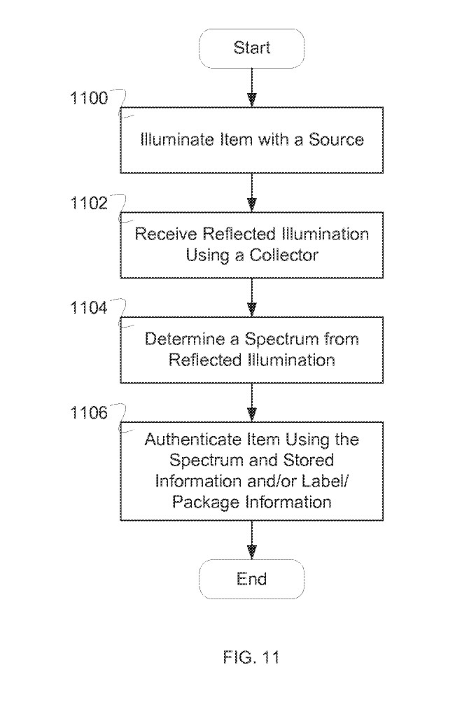

FIG. 11 is a flow diagram illustrating an embodiment of a process for authenticating. In some embodiments, the processor FIG. 11 is used to authenticate an additive manufacturing item of FIG. 1 or FIG. 2. In the example shown, in 1100 an item is illuminated with a source. For example, broadband illumination illuminates the item either all at once or sequentially. In 1102, reflected illumination is received using a collector. In 1104, a spectrum is determined from the reflected illumination. In 1106, the item is authenticated using the spectrum and stored information and/or label/package information. For example, an identifying code is determined from the reflected spectrum and this code is compared to stored information in a database. In some embodiments, authentication of the item comprises checking that information stored in the database and package information, label information, item shape, item type, etc. match.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for generating an item, comprising:
an input receiver to:
receive an additive manufacturing material; and
receive a plurality of tags;
an additive manufacturing device to:
generate an additive manufacturing item using the additive manufacturing material and the plurality of tags.

2. A system as in claim 1, wherein a tag of the plurality of tags comprises a rugate tag.

3. A system as in claim 1, wherein a tag of the plurality of tags comprises one or more of the following materials: silicon, silicon nitride, or doped silicon.

4. A system as in claim 1, wherein a tag of the plurality of tags comprises silica.

5. A system as in claim 1, wherein a tag of the plurality of tags is biologically inert and edible.

6. A system as in claim 1, wherein a tag of the plurality of tags includes a spectral signature for identification.

7. A system as in claim 6, wherein identification identifies one or more of the following: a product manufacturer, a brand, a product type, a model, an individual lot, or a batch.

8. A system as in claim 6, wherein the spectral signature is read using a spectral reader.

9. A system as in claim 1, wherein a tag of the plurality of tags is attached to the additive manufacturing material.

10. A system as in claim 1, wherein a tag of the plurality of tags is embedded within or on the surface of the additive manufacturing material.

11. A system as in claim 1, wherein a tag of the plurality of tags is applied to the additive manufacturing material using a spray.

12. A system as in claim 1, wherein a tag of the plurality of tags is applied to the additive manufacturing material using a coating.

13. A system as in claim 1, wherein a tag of the plurality of tags is applied to the additive manufacturing material using a varnish.

14. A system as in claim 1, wherein a tag of the plurality of tags is applied to the additive manufacturing material as part of a laminate.

15. A system as in claim 1, wherein the additive manufacturing material is extruded.

16. A system as in claim 1, wherein the additive manufacturing material is made fixed or rigid.

17. A system as in claim 16, wherein making fixed or rigid comprises one of the following: cooling, curing, sintering, or polymerizing.

18. A method of generating an item, comprising:
receiving an additive manufacturing material;
receiving a plurality of tags; and
generating, using an additive manufacturing device, an additive manufacturing item using the additive manufacturing material and the plurality of tags.

19. A computer program product for generating an item, the computer program product being embodied in a tangible computer readable storage medium and comprising computer instructions for:
receiving an additive manufacturing material;
receiving a plurality of tags; and
generating, using an additive manufacturing device, an additive manufacturing item using the additive manufacturing material and the plurality of tags.
